(19) United States
(12) Patent Application Publication
(10) Pub. No.: US 2007/0110949 A1
(43) Pub. Date: May 17, 2007

(54) FLOCKED ADHESIVE ARTICLE

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/560,679

(22) Filed: Nov. 16, 2006

Related U.S. Application Data
(60) Provisional application No. 60/738,152, filed on Nov. 17, 2005.

(51) Int. Cl. B32B 33/00

(52) U.S. Cl. 428/90; 428/97

(57) ABSTRACT

A design and process are provided in which a fully activated thermoset adhesive layer is positioned between a flock layer and a thermoplastic adhesive layer.

### CROSS REFERENCE TO RELATED APPLICATION

The present application claims the benefits, under 35 U.S.C. §119(e), of U.S. Provisional Application Ser. No. 60/738,152, filed Nov. 17, 2005, entitled “Flocked Adhesive Article”, which is incorporated herein by this reference.

### FIELD OF THE INVENTION

The invention relates generally to flocked articles and particularly to flocked adhesive articles.

### BACKGROUND OF THE INVENTION

Flocked articles are used in a wide variety of applications. For example, flocked articles are used as patches, transfers, molded objects, and the like. Flock is much less expensive than woven articles while providing a more plush feel. To maintain the plush feel, it is important to not only to provide for the proper orientation of the flock relative to the adhesive layer but also prevent the permanent adhesive from flowing into and between the flock fibers.

One technique for accomplishing these objectives is to adhere a pre-formed, self-supporting thermosetting adhesive film to the flock. The use of the self-supporting film inhibits flow of the adhesive too far up the fibers. The adhesive, when fully activated or cross-linked, can permanently adhere the flock to a desired substrate. A problem, however, exists in the need of a downstream user to apply the high temperatures needed to fully cross-link the adhesive when it is applied to the substrate.

There is thus a need to provide a flocked article having a high degree of plushness and an adhesive that can be applied at lower temperatures, such as the temperature of a hot iron.

### SUMMARY OF THE INVENTION

These and other needs are addressed by the various embodiments and configurations of the present invention. The present invention is directed generally to an article having adjacent thermoset and non-thermosetting (e.g., thermoplastic and hot melt adhesives) adhesive layers arranged so that the thermoset adhesive layer is between the flock and non-thermosetting adhesive layer. Before the thermoplastic adhesive layer is melted, the thermoset adhesive layer is fully activated (or cross-linked) to firmly attach to the flock fibers while inhibiting flow of the non-thermosetting adhesive (after application) into and between the flock fibers. In this manner, a high degree of plushness is maintained in the flock layer without compromising the bond strength between the fibers and thermoset adhesive layer.

In one embodiment, the non-thermosetting adhesive layer is a thermoplastic adhesive, and the thermoset adhesive layer is contacted with the flock fibers and thermoset fully before the thermoplastic adhesive layer is contacted with the thermoset adhesive layer. It has been discovered that, when the two adhesive layers are applied simultaneously or substantially simultaneously to the flock layer, the curing agents can migrate into the thermoplastic adhesive layer and cause it to set irreversibly or thermoset. By applying the adhesive layers at differing times, this problem can be avoided. The curing agents in the previously thermoset thermoset adhesive layer are immobilized by the cross-linking and thereby prevent from migrating into the thermoplastic adhesive layer.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a side view of a flocked carrier sheet according to an embodiment of the present invention;

FIG. 2 is a side view of a flocked intermediate assembly according to an embodiment of the present invention;

FIG. 3 is a side view of a flocked article according to an embodiment of the present invention;

FIG. 4 is a side view of a manufacturing line for the flocked article of FIG. 3; and

FIG. 5 is a flow chart of the manufacturing line of FIG. 4.

### DETAILED DESCRIPTION

While the non-thermosetting adhesive layer is discussed in the embodiments below solely in the context of a thermoplastic adhesive, it is to be understood that the non-thermosetting adhesive may be any adhesive that does not thermoset if heated to a high enough temperature. Rather, non-thermosetting adhesives will only melt if heated to a high enough temperature. For example, thermoplastic adhesives are generally thermally reversible while thermosetting or thermoset adhesives are generally thermally irreversible. By heating thermoplastic adhesives to a high enough temperature, the adhesive may be bonded reversibly to a substrate. Examples of adhesives other than thermoplastic adhesives include hot melt adhesives, binder adhesives, tack adhesives, and the like.

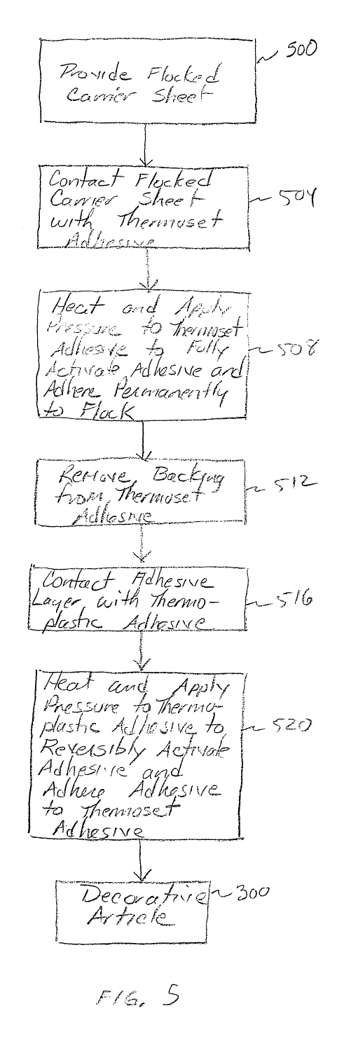

FIG. 3 shows a flocked article 300 according to an embodiment of the present invention. The article 300 includes a carrier sheet 304, release adhesive layer 308, flock layer 312, thermosetting adhesive layer 316, thermoplastic adhesive layer 320, and optional backing material 324. As can be seen from FIG. 3, the flock fibers in the flock layer 312 are substantially perpendicular to the planes of the carrier sheet 304 and adhesive layers 316 and 320 to provide a plush feel. To adhere the article 300 to a desired substrate, the backing material 324 is removed, the adhesive layer 320 placed against the substrate (not shown) surface, and heat and pressure applied to the carrier sheet 304. The heat will melt, at least partially, the thermoplastic adhesive layer 320 (without melting the thermosetting adhesive layer 316). When the heat is removed, the thermoplastic adhesive layer 320 will adhere reversibly (but permanently absent remelting) to the substrate.

The carrier sheet 304 can be any desirable sacrificial carrier, such as cellulose (paper), microporous substrate (such as described in U.S. Pat. No. 6,025,068 and copending U.S. Provisional Application Ser. Nos. 60/628,836, filed Nov. 16, 2005, 60/676,124, filed Apr. 28, 2005, 60/703,925, filed Jul. 28, 2005, 60/704,681, filed Aug. 1, 2005, 60/707,577, filed Aug. 11, 2005, 60/710,368, filed Aug. 22, 2005, 60/716,869, filed Sep. 13, 2005, 60/719,469, filed Sep. 21, 2005, and 60/719,098, filed Sep. 20, 2005, to Abrams, each of which is incorporated herein by this reference), and other known carriers. The release adhesive 308 can be any suitable adhesive, such as those disclosed in any of the above copending U.S. provisional applications.

The flock 312 used in any of the processes discussed herein can be any electrostatically chargeable fiber, such as fibers made from rayon, nylon, cotton, acrylic, and polyester. Preferably, the flock preferably has a melting and/or softening point that is greater than and is resilient under the temperatures and pressures experienced in design manufacturing and later application processes to resist softening, deformation, and melting. Due to its low melt point, acrylic flock is undesirable in many applications. Resilient flock, such as rayon, nylon, and terephthalate (e.g., poly(cyclohexylenedimethylene terephthalate) polymer flock, is particularly preferred. In most applications, the flock orientation is at least substantially orthogonal (perpendicular) to the first side of the elastic film.

The thermosetting adhesive 316 can be any high polymer that solidifies or sets irreversibly when heated above a specific temperature (typically its softening temperature). In other words, the adhesive is commonly non-tacky and thermoplastic in nature as prepared and, upon heating to a suitable temperature, fuses and becomes thermoset or substantially infusible and insoluble. The thermoset state is usually associated with a cross-linking reaction of the molecular constituents induced by heat or radiation. Curing agents, such as organic peroxides and sulfur (in the case of rubber), may be incorporated in the adhesive 316 to facilitate or catalyze the cross-linking reaction. For example, linear polyethylene can be cross-linked to a thermosetting material either by radiation or by chemical reaction. Examples of thermosetting adhesives include rubber, polyolefins, polyesters (e.g., poly(ethylene terephthalate)), polystyrenes, polyethylenes, acrylics, polyurethanes, poly(vinyl chlorides), nylons, phenolics, alkyds, polypropylene, amino resins, polyesters, fluorocarbons, epoxides, rubbers, silicones, and cellulosic and acrylic resins.

In one formulation, the adhesive, when in the thermoplastic state, includes a compound containing three or more isocyanate groups per molecule (such as triphenylmethane, triisocyanate, benzene triisocyanate, tolylene triisocyanate, silicon triisocyanate, ethylene tetraisocyanate, and diphenyl triisocyanate) in which a number of the isocyanate groups are blocked or masked with an isocyanate splitter-type material (such as a phenols and malonic ester), and a polyester containing three or four hydroxyl groups (such as glycerin, trimethylol propane, pentaerythritol, various polyesters with excess hydroxyl groups, and phenol formaldehyde resins). To convert the adhesive to the thermoset state, the adhesive is heated to a higher temperature, for example about 125 degrees Celsius or higher, for a short period of time to free the isocyanate groups from the masking or blocking material and permit their reaction with the hydroxyl groups of the polyester. To accelerate the decomposition reaction or the splitting off of the splitter-type material, a small amount of an accelerator such as a tertiary amine compound, tributyl amine, and tris-(dimethyl aminomethyl) phenol, may be added.

The thermoplastic adhesive 320 can be any high polymer that softens when heated and returns to its original condition when cooled to room temperature. In other words, the post-heated state of the adhesive is reversible while that of a thermoset adhesive is irreversible. The adhesive 320 can be rubber, polyolefins, polyesters (e.g., poly(ethylene terephthalate)), polystyrenes, polyethylenes, acrylics, polyurethanes, poly(vinyl chlorides), nylons, phenolics, alkyds, polypropylene, amino resins, polyesters, fluorocarbons, epoxides, rubbers, silicones, and cellulosic and acrylic resins.

The backing material 324 can be any sacrificial material, including those identified above for the carrier sheet 304. The material 324 is discarded after removal.

The system and process for manufacturing the article 300 will now be discussed with reference to FIGS. 4-5.

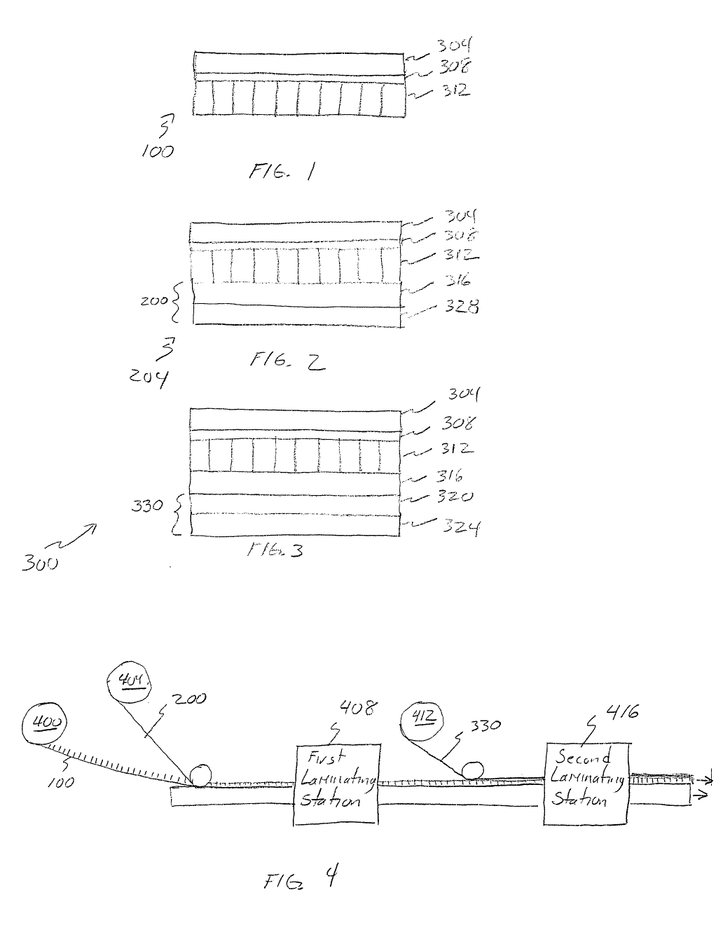

In step 500, a flocked carrier sheet 100 (depicted in FIG. 1) is provided. The flocked carrier sheet 100 is preferably formed by screen printing the release adhesive film 308 in a desired pattern (which is typically the reverse of the desired final flock pattern) on the carrier sheet 304 followed by flocking electrostatically the carrier sheet 304. In the system of FIG. 4, the flocked carrier sheet 100 is dispensed on a first roll 400.

In step 504, the flocked carrier sheet 100 is contacted with a pre-formed, self-supporting thermoset adhesive film 200 (which is a combination of the thermoset adhesive layer 316 in the thermoplastic state and a sacrificial backing material 328 as shown in FIG. 2). In the system of FIG. 4, the film 200 is dispensed on a second roll 404.

While in contact, the flocked carrier sheet 100 and film 200 enter into a first lamination station 408. In the station 408, the film 200 is preferably heated to a temperature of at least about 300 degrees F. and more preferably from about 310 to about 450 degrees F. (or preferably above the softening point of the adhesive layer 316) while pressure (which depends on the density of the flock fibers), preferably of at least about 1 psi and more preferably ranging from about 5 to about 25 psi, is applied to the backing material 328 to cause the flock fibers to penetrate the surface of the adhesive layer 316. As will be appreciated, the orientation can be reversed such that the carrier sheet 304 is on top and the backing material 328 on bottom in which case pressure is applied to the carrier sheet 304. In this step 508, the adhesive layer 316 is heated for a sufficient time (typically from about 15 seconds to about 5 minutes) for the layer 316 to enter into the thermoset state, or cross-link substantially completely. The thermoset adhesive layer 316 will, as noted below, form a blocking layer to inhibit the thermoplastic adhesive layer 320 from flowing into and between the flock fibers and thereby compromising the degree of plushness of the flock fibers.

The flocked intermediate assembly 204 (shown in FIG. 2) is allowed to cool to a temperature below the maximum temperature experienced in the first laminating station 408.

In step 512, the backing material 328 is removed from the fully activated thermoset adhesive layer 316. This can be done by any suitable technique known to those of ordinary skill in the art.

In step 516, the fully activated thermoset adhesive layer 316 (now in the thermoset state) is contacted with the thermoplastic adhesive film 330 (which is a combination of the thermoplastic adhesive layer 320 and backing material 324). In the system of FIG. 4, the film 330 is dispensed on a third roll 412.

While in contact, the assembly 204 and film 330 enter into a second lamination station 416. In the station 416, the film 330 is preferably heated to a temperature of at least about 300 degrees F. and more preferably from about 310 to about 375 degrees F. (or preferably above the softening point of the adhesive layer 320) while pressure (which depends on the density of the flock fibers), preferably of at least about 1 psi and more preferably ranging from about 5 to about 25 psi, is applied to the backing material 324 to cause the adhesive layer 316 to firmly contact and adhere to the adhesive layer 320. As will be appreciated, the orientation can be reversed such that the carrier sheet 304 is on top and the backing material 324 on bottom in which case pressure is applied to the carrier sheet 304. In this step 520, the adhesive layer 320 is heated for a time typically ranging from about 1 to about 15 seconds. The thermoset adhesive layer 316 forms a blocking layer to inhibit the thermoplastic adhesive layer 320 from flowing into and between the flock fibers.

The adhesive layers 316 and 320 have differing properties. As will be appreciated, the adhesive layer 316, when heated, is more viscous (and therefore more resistant to flow) than the adhesive layer 320, when softened. While not wishing to be bound by any theory, this is believed to be from the cross-linking reaction occurring rapidly in the adhesive layer 316. This higher viscosity limits the ability of the softened adhesive layer 316 to flow up and between the flock fibers, thereby maintaining plushness of the flock layer 312. Typically, the softening point of the thermoset adhesive layer 316 in step 508 is greater than the softening point of the thermoplastic adhesive layer 320 in step 520.

The decorative article of FIG. 3 is outputted by the second laminating station 416.

A number of variations and modifications of the invention can be used. It would be possible to provide for some features of the invention without providing others.

For example in one alternative embodiment, decorative media other than flock can be used in the article in place of the flock layer 312. For example, glitter, glass beads, metal foil, and other decorative materials may be employed.

In another alternative embodiment, the thermoset and/or thermoplastic adhesive layers are applied in liquid form rather than solid form.

In yet another alternative embodiment, the flock is applied directly to the thermoset layer 316 with or without an intermediate adhesive on the surface of the layer 316 to hold the flock in position until the flock is pressed into the softened thermoset layer 316 in a lamination station. In one configuration, the thermoset adhesive layer is heated to the point of being tacky (while still in the thermoplastic state) and the flock fibers electrostatically flocked into the tacky adhesive layer. The adhesive layer may then be heated to a higher temperature to soften further and cross-link the adhesive to the thermoset state while the flock fibers are pushed into the softened adhesive. In this embodiment, steps 504, 508, 512, 516, and 520 remain the same, and the intermediate assembly does not have the carrier sheet 304 and release adhesive 308 positioned on top of the flock layer 312.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for manufacturing a flocked article, comprising:
(a) contacting a thermoset adhesive with flock fibers;
(b) fully activating the thermoset adhesive to adhere permanently to the flock fibers;
(c) thereafter contacting the fully activated thermoset adhesive with a non-thermosetting adhesive, the thermoset adhesive being positioned between the flock fibers and the non-thermosetting adhesive; and
(d) heating the non-thermosetting adhesive to adhere the non-thermosetting adhesive to the thermoset adhesive.

2. The method of claim 1, wherein a first surface of the flock fibers is adhered to a release adhesive, the release adhesive being adhered to a carrier sheet and an opposing second surface of the flock fibers is adhered to the thermoset adhesive.

3. The method of claim 1, wherein the non-thermosetting adhesive is a thermoplastic adhesive, wherein the thermoset adhesive prior to step (a) is in the form of a pre-formed, self-supporting solid film, and wherein the thermoplastic adhesive prior to step (c) is in the form of a pre-formed, self-supporting solid film.

4. The method of claim 3, wherein the non-thermosetting adhesive is a thermoplastic adhesive, wherein each of the thermoset adhesive and thermoplastic adhesive films are attached to a backing sheet, and wherein the backing sheet of the thermoset adhesive film is removed before step (c) to provide a surface for adhering to the thermoplastic adhesive film.

5. The method of claim 3, wherein the non-thermosetting adhesive is a thermoplastic adhesive, and wherein the thermoset adhesive film, when heated, is more viscous than the thermoplastic adhesive film.

6. The method of claim 3, wherein the non-thermosetting adhesive is a thermoplastic adhesive, and wherein the softening point of the thermoset adhesive film is greater than the softening point of the thermoplastic adhesive film.

7. The flocked article manufactured by the steps of claim 1.

8. A flocked article, comprising:
(a) a flock layer;
(b) a fully activated thermoset adhesive layer; and
(c) a thermoplastic adhesive layer bonded to the thermoset adhesive layer, the thermoset adhesive layer being positioned between the flock layer and the thermoplastic adhesive layer.

9. The article of claim 8, wherein a first surface of the flock fibers is adhered to a release adhesive, the release adhesive being adhered to a carrier sheet and an opposing second surface of the flock fibers is adhered to the thermoset adhesive.

10. The article of claim 8, wherein the thermoset adhesive layer is in contact with the thermoplastic adhesive layer, wherein the thermoset adhesive prior to contact with the flock layer and thermoplastic adhesive is in the form of a pre-formed, self-supporting solid film, and wherein the thermoplastic adhesive prior to contact with the thermoset adhesive is in the form of a pre-formed, self-supporting solid film.

11. The article of claim 10, wherein the thermoset adhesive layer is in direct contact with the flock layer, wherein each of the thermoset adhesive and thermoplastic adhesive layers are attached to a backing sheet, and wherein the backing sheet of the thermoset adhesive layer is removed before contact with the thermoplastic adhesive layer.

12. The article of claim 10, wherein the thermoset adhesive layer, when heated, is more viscous than the thermoplastic adhesive layer.

13. The article of claim 10, wherein the softening point of the thermoset adhesive layer is greater than the softening point of the thermoplastic adhesive layer.
